(19) United States
(12) Patent Application Publication
(10) Pub. No.: US 2001/0008276 A1
(43) Pub. Date: Jul. 19, 2001

(54) Hose with integral valve

(75) Inventor: Kevin C. Assenheimer, Bucyrus, OH (US)

Correspondence Address: Joseph V. Tassone, c/o Dayco Products, Inc., 1 Prestige Place, Dayton, OH, 45401-1004, US

(73) Assignee: Dayco Products, Inc., Dayton, OH (US)

(21) Appl. No.: 09/800,197

(22) Filed: Mar. 6, 2001

Related U.S. Application Data
(63) Continuation of application No. 09/430,787, filed on Oct. 28, 1999.

(51) Int. Cl. F16K 5/06

(52) U.S. Cl. 251/152

(57) ABSTRACT

A liquid conveying hose with an integral valve mounted on the end connector thereof. The valve allows the user to control the volume of the liquid at the end of the hose even though distant from the supply. The flow of liquid can be turned on or off or reduced to any volume therebetween.

### BACKGROUND OF THE INVENTION

1. Field of the Invention

This invention relates to a liquid conveying hose, such as a garden hose, having means for controlling flow of the liquid therethrough.

2. Prior Art Statement

Most water hoses, such as used for watering yards and gardens, or for washing an auto, control the amount of water, or turn the water flow on and off, by first using a faucet or spigot attached to the water supply. Secondarily, a nozzle may be attached to the male coupling of the hose either to control the type of spray emanating from the hose, or to turn off the water from the hose. It is also known to provide a support member for the hose which incorporates a valve, faucet or spigot, such as shown in the patents to Gilpin, U.S. Pat. No. 1,031,176; Lakey, U.S. Pat. No. 4,800,916; and Potter, U.S. Pat. No. 5,524,667.

### SUMMARY OF THE INVENTION

The present invention provides another approach to the user's control of the water carried through his hose. This is accomplished by placing a valve directly on the male end connector of the hose, where a spray nozzle would ordinarily be connected. This valve could then be selectively used to permit the water to flow (once the faucet at the hose supply is turned on), to turn the water flow off, or to position the valve for controlling the amount of water which can flow. This has several advantages over existing systems; it enables the gardener to control water flow when he is holding the hose far from the water supply faucet without having to return to the faucet; and eliminates that need for a conventional nozzle for controlling the water supply. Thus the user can directly control the supply if he wishes to use the hose without a nozzle, or he can use different types of nozzles which have no controls. For example, he can use a fan-shaped sprayer or a jet-type nozzle of the types in common usage. The valve may be of any suitable type, such as a ball valve (globe valve), needle valve, poppet valve, or the like. In ordinary use, the user will turn the valve off and turn on the faucet at the source of supply, carry the hose to the place where he wishes to use it, such as a flower bed or an auto, then use the valve to allow flow of water in the desired volume.

It is a principal object of this invention, therefore, to provide a liquid conveying hose with an integral valve.

It is a further object to provide such valve in an end connector.

It is another object to use such valve control the flow of the liquid without the need to return to the control device at the source of supply.

These and other objects will become apparent in the following description of the drawings.

### BRIEF DESCRIPTION OF THE DRAWINGS

FIG. 1 is a side elevational view of a hose assembly having a novel valve arrangement.

FIG. 2 is an end view of the assembly.

FIG. 3 is a sectional view of the assembly of FIG. 1 taken along line 3-3 of FIG. 2, showing the valve in the “on” position.

FIG. 4 is a sectional view of the assembly of FIG. 1 taken along line 4-4 of FIG. 1.

FIG. 5 is a view similar to FIG. 4 showing the valve in the “off” position.

FIG. 6 is a view similar to FIGS. 4 and 5 showing the valve in an intermediate position.

### DESCRIPTION OF PREFERRED EMBODIMENTS

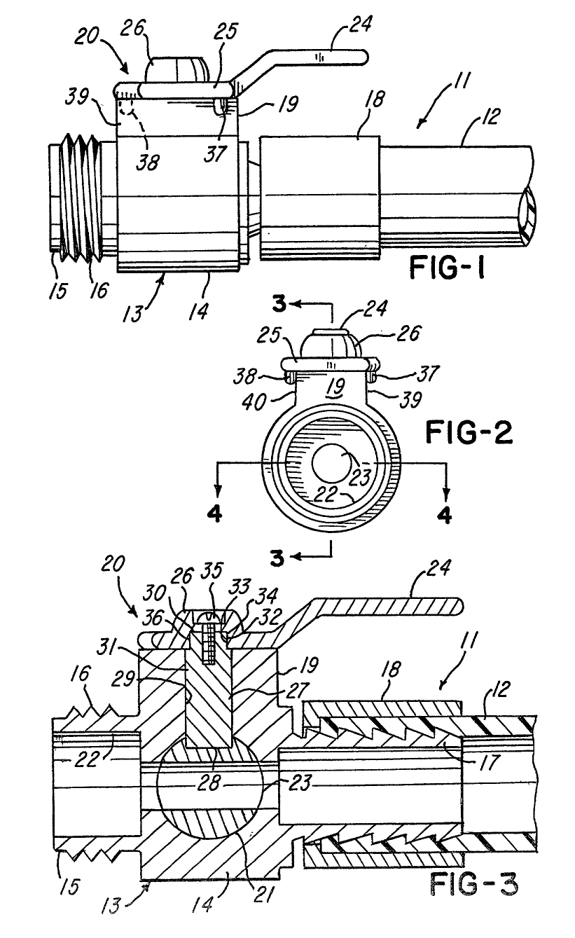

FIGS. 1 to 6 illustrate a hose assembly 11 comprising a typical garden hose 12 made of a polymeric material such as rubber or plastic, having a coupling 13 made of metal such as brass or steel. The coupling has a cylindrical hollow main body 14 which has one end portion 15 having male or external threads 16 adapted to engage a standard controllable hose nozzle or other types of hose nozzles which are not separately controlled, having female or internal threads. The other end of the coupling has a hollow ferrule 17 which fits into the inner diameter of the hose 12 and is secured by crimping a collar 18 around the exterior of the hose. A rectangular bass 19 is integral with one segment of the coupling.

The control of water flow is accomplished by the use of a valve 20 which is integral with the coupling. The salient portion of the valve is a control ball or sphere 21 which is mounted within the inner surface 22 of the coupling and is longitudinally aligned with the bass 19. The outer radius of the ball is approximately equal to the inner surface 22 so that a seal is accomplished therebetween. An opening 23, parallel to the longitudinal plane of the coupling, extends through the ball. As seen in FIGS. 1 to 4, the opening is aligned with the longitudinal axis of the hose assembly to permit maximum flow of the liquid (“on” position). In FIG. 5, the opening is positioned at right angles, or 90 degrees, to the axis so that the liquid is prevented from flowing (“off” position). In FIG. 6, the opening is partially opened so that flow is partially restricted.

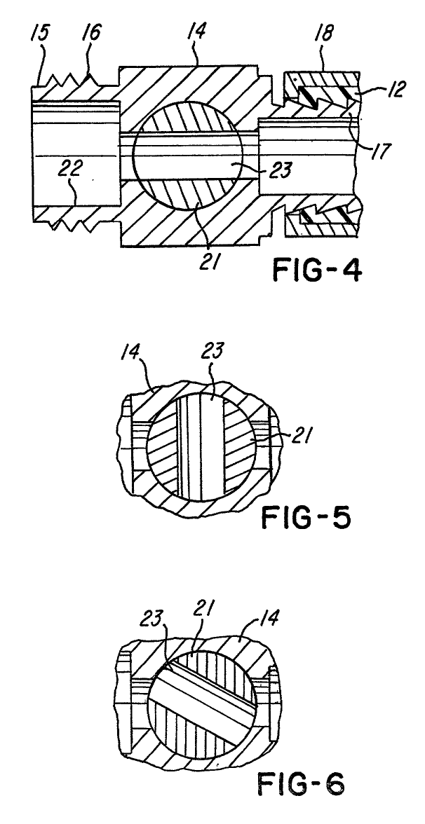

The control ball as manually actuated by means of a valve handle 24 that is integral with a generally trapezoidal plate 25 having an outwardly extending projection 26. The plate is mounted on a shaft 27 having a circular cross-section that is connected at its inner end 28 to the portion of the ball which is aligned with the boss 19, and projects outwardly through an opening 29 of the boss and terminates beyond the boss in an outer end 30. The portion 31 of the shaft is retained within the boss opening. The end 30 is generally circular in cross-section but has flat surfaces 32 which fit within an opening 33 in the plate, having similar flat surfaces 34 to provide a lateral locking grip. The plate is secured in a radial direction by means of a screw 35 which projects inwardly through an opening 36 in the plate projection 26, as well as through the opening 33 in the plate, and into the outer portion of the bass opening 29, which is suitably threaded to receive the screw. At opposite ends of the plate are integral tangs 37 and 38 which project inwardly and are adjacent the vertical surfaces 39 and 40 of the boss, these tangs acting as straps when the handle and plate are rotated. Tang 37 prevents the handle from being further rotated when the “open” position of the valve is desired, after the handle is rotated in a counter-clockwise direction, thus preserving the open position as shown in FIGS. 1, 2 and 3, so that the handle will not accidentally go around again to a “closed” position. When the handle is rotated in a clockwise direction to create the “closed” position of FIG. 4, the tang 38 prevents the handle from exceeding that position so that the handle will not go around again toward the “open” position. As noted above, the handle may be rotated to any desired clockwise or counter-clockwise position to obtain reduced flows of liquid, such as shown in FIG. S.

It should be understood that the specific valve handle 24 and plate 25 could be replaced by other handles to accomplish the same purpose. For example, a wheel-shaped member, such as found on most garden faucets, could be used in much the same manner. Also, completely different types of valves may be used to accomplish the same results. For example, a needle valve, of the type used in standard hose nozzles; screw valves; or poppet valves may be used. Also, other forms of construction may be used as being within the scope of the invention.

What is claimed is:

1. In a liquid conveying hose assembly having a flow path therethrough comprising a hose and an end connector attached thereto; the improvement comprising valve means integral with said end connector for selective control of said liquid flow from said hose through said end connector.

2. The valve of claim 1 wherein said end connector has a male threaded fitting.

3. The valve of claim 1 comprising closure means located in said flow path and having further means located relative to said flow path for said selective control.

4. The valve of claim 3 wherein said closure means is adapted to selectively prevent flow of said liquid, to permit maximum flow of said liquid, or to permit partial flow of said liquid.

5. The valve of claim 3 comprising manual means for controlling said closure means.

6. The valve of claim 5 comprising means for locking said manual means into a selected position.

7. The valve of claim 1 wherein said valve means comprises a spherical closure member in said flow path to provide said selective control of said liquid flow.

8. The valve of claim 7 wherein said spherical closure member comprises an opening therethrough located relative to said flow path for said selective control.

9. The valve of claim 8 wherein said opening is positioned longitudinally of said flow path to permit maximum flow of said liquid.

10. The valve of claim 8 wherein said opening is positioned at right angles to said flow path to prevent said flow of said liquid.

11. The valve of claim 8 wherein said opening is adapted to be selectively placed between a longitudinal and a right angle position relative to said flow path to control the volume of flow of said liquid.

12. The valve of claim 7 wherein said valve comprises a handle mounted on the outer surface of said end connector, said handle operatively connected to said spherical closure member for manually controlling said closure member.

13. In a liquid conveying hose assembly having a flow path therethrough and comprising a hose and an end connector attached thereto, the improvement comprising a method of providing valve means integral with said end connector for selective control of said liquid flow from said hose through said end connector.

14. The method of claim 13 further comprising the steps of providing closure means in said flow path, and providing further means in said closure means relative to said flow path for said selective control.

15. The method of claim 14 further comprising the further step of utilizing said closure means to selectively prevent flow of said liquid, to permit maximum flow of said liquid, or to permit partial flow of said liquid.

16. The method of claim 14 comprising the further step of manually controlling said closure means.

17. The method of claim 14 comprising the further step of locking said valve means into a selected position.

18. The method of claim 14 comprising the further steps of forming said closure means in a spherical configuration, providing an opening in said closure means, and positioning said opening relative to said flow path for said selective control.

19. The method of claim 18 comprising the further step of positioning said opening longitudinally of said flow path to permit maximum flow of said liquid.

20. The method of claim 18 comprising the further step of positioning said opening at right angles to said flow path to prevent said flow of said liquid.
